(19) United States
(12) Patent Application Publication
(10) Pub. No.: US 2009/0228411 A1
(43) Pub. Date: Sep. 10, 2009

(54) REDUCING METHOD FOR SUPPORT VECTOR

(75) Inventors: Kazunori MATSUMOTO, Saitama (JP); Dung Duc NGUYEN, Saitama (JP); Yasuhiro TAKISHIMA, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 12/399,236

(22) Filed: Mar. 6, 2009

(30) Foreign Application Priority Data
Mar. 6, 2008 (JP) 2008-056602

(51) Int. Cl. G06F 15/18

(52) U.S. Cl. 706/12

(57) ABSTRACT

To provide a method capable of reducing support vectors without decreasing the performance of an SVM. The method includes: a step of learning an SVM by using a set of training samples for initial learning which have known labels; a step of evaluating a training sample for initial learning corresponding to an outlier (value greater than 0 and equal to or less than C) based on a parameter a value obtained by learning the SVM; and a step of removing the training sample for initial learning corresponding to the outlier from a set of the original training samples for initial learning.

### BACKGROUND OF THE INVENTION

1. Field of the Invention

The present invention relates to a reducing method for a support vector, and particularly, relates to a method for reducing a support vector, suitably used for re-learning a support vector machine (SVM).

2. Description of the Related Art

In Patent Document 1 hereinafter and in the existing documents referred to as a related art in Patent Document 1, a feature extraction method for detecting a shot boundary is disclosed. As Patent Document 1 clearly specifies, the obtained feature amount is classified by using a pattern recognizer such as a support vector machine (SVM). In the SVM, before the classification process, the training samples previously prepared are used for learning so as to construct model data for classification called a support vector.

On the other hand, in the classification process by the SVM, the classification process takes time in proportion to the number of support vectors used as models. Therefore, if there is a need for speeding up the process even at the cost of classification accuracy, the model needs to be simplified by reducing the number of support vectors. In Non-Patent Document 1 hereinafter, a specific technique is disclosed for reducing the number of support vectors without significantly lowering the classifying performance of a constructed classifier.

Patent Document 1: Japanese Published Unexamined Patent Application No. 2007-142633

Non-Patent Document 1: “An Efficient Method for Simplifying Support Vector Machines,” Proc. of 22^{nd} Int. Conf. Machine learning, Bonn, Germany, 2005, Aug. pp. 617-624

If the technologies described in Patent Document 1 and Non-Patent Document 1 are combined, i.e., if the classifier for shot detection (SVM) is constructed once based on learning, and thereafter, the support vectors are reduced, it may become possible to construct a high speed SVM-based classifier, without losing much in accuracy. However, in Non-Patent Document 1, since the existence of an outlier is not taken into consideration, when the outlier exists near the original classification boundary before the support vectors are reduced, the outlier is not targeted for reduction, and thus, the optimum simplification cannot be performed. As a result, sometimes a phenomenon occurs where the performance of the classifier after the support vectors are deleted worsens sharply, as compared to the initial performance.

### SUMMARY OF THE INVENTION

An object of the present invention is to provide a method capable of reducing support vectors without lowering the performance of an SVM.

In order to achieve the object, a feature of this invention is that a reducing method for a support vector comprises a step of learning an SVM by using a set of training samples for initial learning which have known labels, a step of evaluating a training sample for initial learning corresponding to an outlier based on a parameter α value obtained by learning the SVM, and a step of removing the training sample for initial learning corresponding to the outlier from a set of the original training samples for initial learning.

Another feature of this invention is that the training sample for initial learning corresponding to the outlier is a sample near one soft margin hyperplane.

According to the present invention, the number of support vectors of SVM (classifier), obtained by re-learning after the removal of the outlier, is smaller than the number of support vectors for initial learning before the re-learning. Even so, the classification accuracy is mostly not reduced. On the contrary, it has been ascertained in experiments that the classification accuracy improves due to the increased generalization.

Meanwhile, when the outlier near one soft margin hyperplane is removed, it becomes possible to re-learn at a higher speed the SVM suitable for detecting the shot boundary of an image.

Further, when the number of support vectors is reduced by using the technique in Non-Patent Document 1 after reducing the support vectors by the outlier removal, the reduction effect of support vectors increases without undermining the classification performance, as compared to the case where the support vectors are reduced by using only the technique described in Non-Patent Document 1.

### BRIEF DESCRIPTION OF THE DRAWINGS

FIG. 1 is a flowchart showing a brief process procedure of the present invention.

FIG. 2 is a graph of a logistic function indicating a conditional probability obtained from training data of an instantaneous cut detection.

FIG. 3 is a diagram describing a positional relationship on a kernel space between a hyperplane representing a soft margin and a support vector.

### DETAILED DESCRIPTION OF THE PREFERRED EMBODIMENTS

An overview of the present invention will be described below. First, initial learning (pilot leaning) is performed by using training data (a set of training samples) so as to produce a set of support vectors once. Subsequently, a process for removing a training sample corresponding to that in which an internal parameter (α value) corresponding to a support vector is equal to or more than a threshold value, i.e., a removal process for an outlier, is performed. Subsequently, the remaining training sample data is used for re-learning so as to produce a support vector set. Next, the support vectors are finally reduced by using the technique described in Non-Patent Document 1.

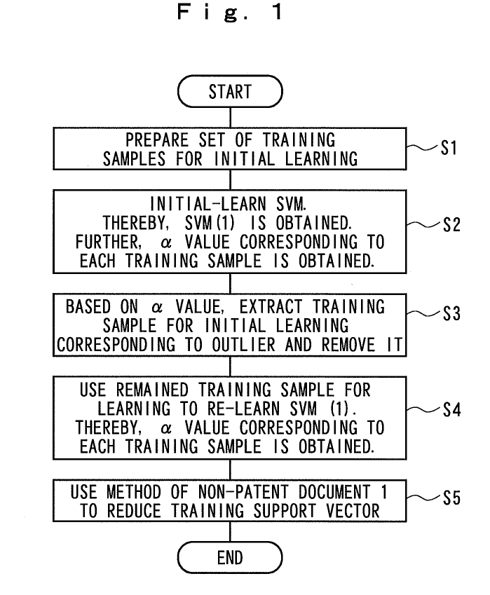

Subsequently, one embodiment of the present invention will be described with reference to a flowchart in FIG. 1.

First, at step S1, a set of training samples i (i=1, 2, m) for initial learning is prepared. For the set of training samples for initial learning, data {x1, x2, x3, . . . , xm} having known class labels {y1, y2, y3, . . . , ym} is prepared. At step S2, the set of training samples for initial learning is used to perform initial learning of SVM. Through this process, a parameter (αᵢ value) corresponding to the training sample i for initial learning is obtained, as well as an initially learned SVM (1).

At step S3, a training sample i′ for initial learning corresponding to the outlier is evaluated based on the parameter αᵢ, and the training sample i′ for initial learning corresponding to the outlier is deleted from the set of original training samples i for initial learning. The outlier will be described in detail later.

At step S4, the reduced training sample is used to re-learn the SVM (1). Thereby, the parameter α value corresponding to each training sample is obtained. At step S5, the method described in Non-Patent Document 1 is used to further reduce the training support vectors. It is noted that the reducing method for a support vector in Non-Patent Document 1 is described in detail in Non-Patent Document 1, and therefore, description will be omitted. The principle, however, will be briefly described: one new vector is created from two nearest support vectors belonging to the same class, and the two support vectors are replaced with the one new support vector, whereby the support vectors are reduced.

In the normal SVM, a soft margin for performing linear separation allowing some classification errors is used. Obviously, the data for shot boundary detection cannot also be linearly separated on the kernel space; therefore, learning is performed by using the SVM by the soft margin. A hyperparameter value for this soft margin is represented by C. A classification function Φ (x) is written as follows:

$$Φ ( x ) = sign ( {\sum }_{i = 1}^{N} {α}_{i} {y}_{i} k ( {X}_{i} , X ) + b ) \qquad [ Equation 1 ]$$

However, 0≦αᵢ≦C.

In the Equation 1, xᵢ represents the sample data for learning, x represents the sample, yᵢ(=+1 or −1) represents the class label, and αᵢ represents the internal parameter, representing a Lagrange multiplier, for example. In the present embodiment, a sample of y=−1 is a shot boundary and when y=+1, it is not a shot boundary. k(xᵢ, xⱼ) represents a kernel function, and in a case of Gaussian kernel, it is k(xᵢ, xⱼ)=exp{−γ·∥xᵢ−xⱼ∥}.

A sample corresponding to 0<αᵢ is called a support vector. In particular, a support vector of 0<αᵢ<C exists on margin hyperplanes H1 and H2. The details will be described later with reference to FIG. 3.

If the distribution of class estimation results obtained by using the learned SVM is approximated with a logistic function, the classification performance often improves. Actually, in the shot boundary detection, using the logistic function further improves the accuracy.

$$f ( x ) = {\sum }_{i = 1}^{N} {α}_{i} {y}_{i} k ( {X}_{i} , X ) + b \qquad [ Equation 2 ]$$

With this, a logistic function P representing a conditional probability of each class is represented by the following equation:

$$P ( y = - 1 \vert x ) = \frac{1}{1 + exp ( Af ( x ) + B )} \\ P ( y = + 1 \vert x ) = \frac{exp ( Af ( x ) + B )}{1 + exp ( Af ( x ) + B )} \qquad [ Equation 3 ]$$

A and B are calculated by using maximum likelihood estimation from the sample data for training.

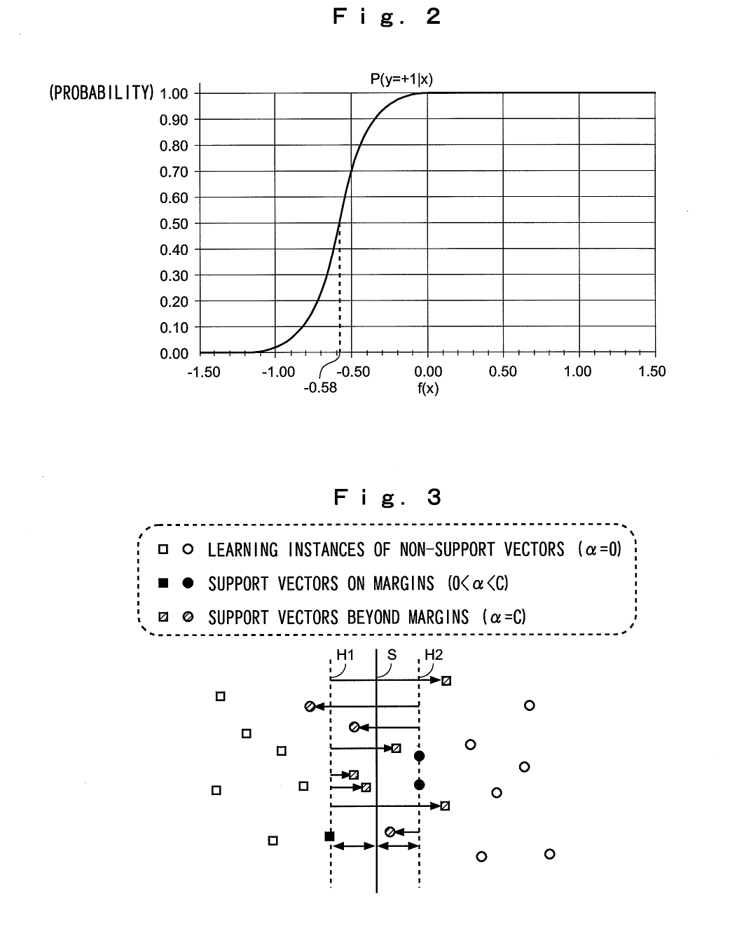

FIG. 2 is a graph for the logistic function of SVM constructed from the training data for actual cut detection (=partial problem of shot boundary detection).

If the SVM learning is executed once (the step S2), a value of αᵢ corresponding to each training sample i is obtained. As shown in FIG. 3, vectors □ and ◯ of which the values are αᵢ=0 are non-support vectors, vectors of which the values are 0<αᵢ<C are support vectors, and support vectors ▪ and of which the values are 0<αᵢ<C are present on margins H1 and H2. Further, support vectors of which the values are αᵢ=C are those which exceed the margins.

Meanwhile, when the αᵢ value is equal to or more than a certain threshold value, the corresponding training sample is determined as the outlier. This threshold value can be set to a value of an appropriate size (however, a value greater than 0 and equal to or less than C) as required. As a preferable example, the training sample for initial learning corresponding to the outlier can be a sample in which the parameter α value is equal to the value of hyper parameter C for a soft margin, where the threshold value is C.

A support vector, which is an outlier, has a high possibility of being near the classification boundary surface S and there is a possibility that this vector is wrongly labeled. Therefore, if the support vector which is the outlier is added as a new sample, there is a likelihood that the performance of SVM will deteriorate.

Consequently, according to the present embodiment, the number of support vectors used for SVM re-learning reduces only by the number of removed support vectors which are outliers, but irrespective of that, the classification accuracy of SVM mostly does not deteriorate. On the contrary, since the number of support vectors becomes small, the speed of re-learning improves.

Subsequently, a second embodiment of the present invention will be described. In the shot boundary detection problem which is a subject in the present embodiment, the number of shot boundary instances is significantly fewer as compared to that of non-shot boundary instances. Therefore, when a conditional probability indicated by the logistic function obtained by sigmoid training is evaluated, in the support vectors existing on the margin hyperplane on a side of “class of non-shot boundary instances,” the probability of “class of shot boundary instances” is almost zero. On the contrary, in the support vectors existing on the margin hyperplane of “class of shot boundary instances,” the probability of “class of non-shot boundary instances” is somewhat high.

As mentioned above, in the shot boundary detection problem which is a subject in the present embodiment, since the number of shot boundary instances is significantly fewer as compared to that of the non-shot boundary instances, the determined position in the logistic function in FIG. 2 enters into f(x)=−0.58 and the left side (y=−1, i.e., the side of the shot boundary class). As mentioned above, even in the sample existing on the soft margin hyperplane with f(x)=−1, the conditional probability of “non-shot boundary class” does not become zero. This indicates that two classes are mixed near the hyperplane on the kernel space.

On the contrary, in f(x)=+1, which represents the soft margin hyperplane of a non-shot boundary class, the conditional probability of a non-shot boundary class is almost 1.0, and therefore, the vicinity of hyperplane is configured only by the non-shot boundary class instances. In the support vectors existing on the hyperplane of f(x)=−1, the reliability of the imparted label is also high and the separation from the other classes in the vicinity (=non-shot boundary classes) is not very good.

Due to these reasons, in the present embodiment, the outlier existing on the margin hyperplane of “class of shot boundary instances” is removed.

1. A reducing method for a support vector comprising:
a step of learning an SVM by using a set of training samples for initial learning which have known labels;
a step of evaluating a training sample for initial learning corresponding to an outlier based on a parameter α value obtained by learning the SVM; and
a step of removing the training sample for initial learning corresponding to the outlier from a set of the original training samples for initial learning.

2. The reducing method for a support vector according to claim 1, wherein the training sample for initial learning corresponding to the outlier is a sample near one soft margin hyperplane.

3. The reducing method for a support vector according to claim 1, wherein the training sample for initial learning corresponding to the outlier is a sample in which a value of the parameter α value is equal to a value of a hyper parameter C for a soft margin.

4. The reducing method for a support vector according to claim 1, further comprising:
a step of re-learning the SVM by using a training sample in which the training sample for initial learning corresponding to the outlier is removed; and
a step of evaluating a support vector based on the parameter α value obtained by the re-learning so as to create one new vector from the two closest support vectors belonging to the same class, thereby replacing the two support vectors with the one new support vector.

5. The reducing method for a support vector according to claim 2, further comprising:
a step of re-learning the SVM by using a training sample in which the training sample for initial learning corresponding to the outlier is removed; and
a step of evaluating a support vector based on the parameter α value obtained by the re-learning so as to create one new vector from the two closest support vectors belonging to the same class, thereby replacing the two support vectors with the one new support vector.

6. The reducing method for a support vector according to claim 3, further comprising:
a step of re-learning the SVM by using a training sample in which the training sample for initial learning corresponding to the outlier is removed; and
a step of evaluating a support vector based on the parameter α value obtained by the relearning so as to create one new vector from the two closest support vectors belonging to the same class, thereby replacing the two support vectors with the one new support vector.
